(19) United States
(12) Patent Application Publication
(10) Pub. No.: US 2021/0295676 A1
(43) Pub. Date: Sep. 23, 2021

(54) SMOKE GENERATOR PERFORMANCE MONITORING

(71) Applicant: Kidde Technologies, Inc., Wilson, NC (US)

(72) Inventor: Mark P. Fazzio, Wilson, NC (US)

(21) Appl. No.: 17/206,239

(22) Filed: Mar. 19, 2021

Related U.S. Application Data
(60) Provisional application No. 62/992,278, filed on Mar. 20, 2020.

(51) Int. Cl. G08B 29/14; F41H 9/06; G08B 17/113

(52) U.S. Cl. CPC G08B 29/145; G08B 17/113; F41H 9/06

(57) ABSTRACT

A test kit includes a tube arranged to channel smoke generated by a smoke generator, a mount arranged to support the tube relative to the smoke generator in a predetermined orientation and a predetermined spacing relative to the smoke generator, and a sensor. The sensor is arranged for coupling to the tube and generating data indicative of one or more property of the smoked generated by the smoke generator and channeled by the tube to monitor performance of the smoke generator. Test arrangements, test systems, and methods of monitoring smoke generators are also described.

### CROSS-REFERENCE TO RELATED APPLICATIONS

This application claims priority to U.S Provisional Application No. 62/992,278 filed Mar. 20, 2020, the contents of which are incorporated herein by reference in their entirety.

### BACKGROUND

The present disclosure is generally related to fire suppression systems, and more particularly to monitoring performance of smoke generators employed for testing fire suppression systems.

Vehicles, such as aircraft, commonly employ fire suppression systems to protect the vehicle fire within the vehicle. Such fire protection systems commonly employ sensors arranged to detect the presence of smoke within protected spaces located within the vehicle. Reliability of the fire protection system is generally tested be introducing smoke into the space protected by the fire suppression systems and monitoring the response of the fire suppression system to the smoke. Reliability can be assessed by whether or not the fire suppression system detects the smoke and, when detected, the time between the introduction of the smoke and detection of the smoke by the fire suppression system. The smoke is typically introduced into the space protected by the fire protection device by a smoke generator, which generates smoke having properties which the fire suppression system is expected to detect.

One challenge to testing fire suppression systems is variation of the smoke generated by a given smoke generator. For example, variation in the size of particles contained within smoke issued by different smoke generators can influence the ability of a given fire suppression system to detect presence of smoke as larger particles can take longer to reach the system sensor that smoke containing smaller particles. Such variation in the smoke used to test the fire protection system can cause the test to overstate or understate the reliability of the fire protection system, potentially leading to the certification of an unreliable system or repair of a healthy system.

Such systems and methods have generally been acceptable for their intended purpose. However, there remains a need for improved test kits, test arrangements, test systems, and methods of monitoring smoke generator performance.

### BRIEF DESCRIPTION

Disclosed is a test kit testing fire suppression systems. The test kit includes: a tube arranged to channel smoke generated by a smoke generator; a mount arranged to support the tube relative to the smoke generator in a predetermined orientation and a predetermined spacing relative to the smoke generator; and a sensor arranged for coupling to the tube, wherein the sensor is configured to generate data indicative of one or more property of the smoked generated by the smoke generator and channeled by the tube to monitor some generator performance.

In addition to one or more of the features described above, or as an alternative to any of the foregoing embodiments, the test can further include a computer program product including a plurality of program modules having instructions that, when read by a processor, cause the processor to: acquire data indictive of the one or more property of the smoke generated by the smoke generator and channeled by the tube; compare the data indicative of the one or more property to one or more predetermined value associated with the one or more property; and indicate, at a user interface operatively associated with the processor, performance of the smoke generator based on the comparison of the data indicative of the one or more property with the one or more predetermined value associated with the one or more property.

A test arrangement for testing a first suppression system is also disclosed. The arrangement can include a smoke generator; and a test kit as in any prior embodiment wherein the tube is supported by the mount in the predetermined orientation and at the predetermined spacing relative to the smoke generator.

In addition to one or more of the features described above, or as an alternative to any of the foregoing arrangement embodiments, the tube has a first open and a second open end coupled to the first open end by an intermediate portion of tube, wherein the tube is supported by the mount such that the second open end is above the first open end relative to gravity.

In addition to one or more of the features described above, or as an alternative to any of the foregoing arrangement embodiments, the sensor is coupled first open end and the second open end of the tube to generate at least one of smoke rise time and smoke settling time data of smoke channeled by the tube.

In addition to one or more of the features described above, or as an alternative to any of the foregoing arrangement embodiments, the sensor is coupled to one or more of the first open end, the second open end, and the intermediate portion of the tube to generate data indicative of one or more of smoke temperature, smoke density, and/or particulate size within an interior of the tube.

In addition to one or more of the features described above, or as an alternative to any of the foregoing arrangement embodiments, the tube is formed from a transparent material, and wherein the tube optically couples the sensor to smoke channeled by the tube and/or disposed within an interior of the tube.

In addition to one or more of the features described above, or as an alternative to any of the foregoing arrangement embodiments, the mount supports the sensor relative to the tube.

In addition to one or more of the features described above, or as an alternative to any of the foregoing arrangement embodiments, the arrangement may further include a link connected to the sensor; and a controller connected to the link and therethrough to the sensor. The control may be configured to: acquire data indictive of the one or more property of the smoke generated by the smoke generator and channeled by the tube; compare the data indicative of the one or more property to one or more predetermined value associated with the one or more property; and indicate, at a user interface operatively associated with the controller, performance of the smoke generator based on the comparison of the data indicative of the one or more property with the one or more predetermined value associated with the one or more property.

In addition to one or more of the features described above, or as an alternative to any of the foregoing arrangement embodiments, the sensor is configured to generate data indicative of one or more of (a) smoke rise time, (b) smoke settling time, (c) smoke temperature, (d) smoke density, and (e) particulate size.

Also disclosed is a test system for testing fire suppression systems that includes: a smoke generator; a test kit as recited in prior embodiment, wherein the tube is supported by the mount in the predetermined orientation and at the predetermined spacing relative to the smoke generator, wherein the sensor is coupled to the tube; and a controller disposed in communication with the sensor with a processor and a memory, the memory having a plurality of program modules recorded on the memory that, when read by the processor, cause the processor to: acquire data indicative of the one or more property of the smoke generated by the smoke generator and channeled by the tube; compare the data indicative of the one or more property to one or more predetermined value associated with the one or more property; and indicate, at a user interface operatively associated with the controller, performance of the smoke generator based on the comparison of the data indicative of the one or more property with the one or more predetermined value associated with the one or more property.

In addition to one or more of the features described above, or as an alternative to any of the foregoing test system embodiments, the sensor is coupled first open end and the second open end of the tube, and wherein the data is one of smoke rise time and smoke settling time within an interior of the tube.

In addition to one or more of the features described above, or as an alternative to any of the foregoing test system embodiments, the sensor is coupled to wherein the sensor is coupled to one or more of the first open end, the second open end, and the intermediate portion of the tube; and wherein the data is indicative of one or more of smoke temperature, smoke density, and particulate size.

Also disclosed is a method of monitoring performance of a smoke generator. The method includes: at a test arrangement including a smoke generator and a test kit including a tube, a mount, and a sensor, wherein the tube is supported by the mount in the predetermined orientation and at the predetermined spacing relative to the smoke generator; generating smoke with the smoke generator; channeling the smoke generated by the smoke generator with the tube; acquiring data indicative of one or more property of the smoke generated by the smoke generator and channeled by the tube from the sensor; comparing the data indicative of the one or more property to one or more predetermined value associated with the one or more property; and indicating at a user interface performance of the smoke generator based on the comparison of the data indicative of the one or more property with the one or more predetermined value associated with the one or more property to monitor performance of the smoke generator.

In addition to one or more of the features described above, or as an alternative to any of the foregoing method embodiments, the data includes smoke rise time, and wherein the predetermined value includes an expected smoke rise time between a first open end and a second open end of the tube.

In addition to one or more of the features described above, or as an alternative to any of the foregoing test system embodiments, the data includes smoke settling time, and wherein the predetermined value includes an expected smoke settling time between a second open end and a first open end of the tube.

In addition to one or more of the features described above, or as an alternative to any of the foregoing test system embodiments, the data includes smoke temperature, and wherein the predetermined value includes an expected smoke temperature.

In addition to one or more of the features described above, or as an alternative to any of the foregoing test system embodiments, the data includes smoke density, and wherein the predetermined value includes an expected smoke density of the smoke channeled by the tube.

In addition to one or more of the features described above, or as an alternative to any of the foregoing test system embodiments, the data includes particulate size, and wherein the predetermined value includes an expected particulate size of the smoke channeled by the tube.

In addition to one or more of the features described above, or as an alternative to any of the foregoing test system embodiments, the method can further include normalizing a response of a fire suppression system in communication with smoke to the data indicative of one or more property of the smoke.

Technical effects of the present disclosure include the capability of accurate assess the performance of fire suppression systems. In certain examples the present disclosure provides the capability to separate the performance of the smoke generator employed to test a fire suppression system and the performance of the smoke generator. In accordance with certain examples the performance of the fire suppression system can be normalized for performance of the smoke generator employed for testing the fire suppression system.

### BRIEF DESCRIPTION OF THE DRAWINGS

The following descriptions should not be considered limiting in any way. With reference to the accompanying drawings, like elements are numbered alike:

FIG. 1 is a schematic view of a test kit in accordance with the present disclosure, showing elements of the test kit including a tube for channeling smoke generated by a smoke generator and sensor for acquiring data indicative of one or more property of the smoke;

FIG. 2 is a schematic view of a test arrangement including the test kit of FIG. 1, showing a mount supporting the tube at a predetermined orientation and spacing from a smoke generator and the sensor coupled to the tube while acquiring data indicative of one or more property of smoke channeled by the tube;

FIG. 3 is schematic view of a test system including the kit of FIG. 1, showing a controller disposed in communication with the sensor and comparing the data acquired by the sensor to one or more predetermined limit associated with the one or more property of the smoke channeled by the tube; and

FIG. 4 is a block diagram of a smoke generator performance monitoring method, showing operations of the method according to an illustrative and non-limiting example of the method.

### DETAILED DESCRIPTION

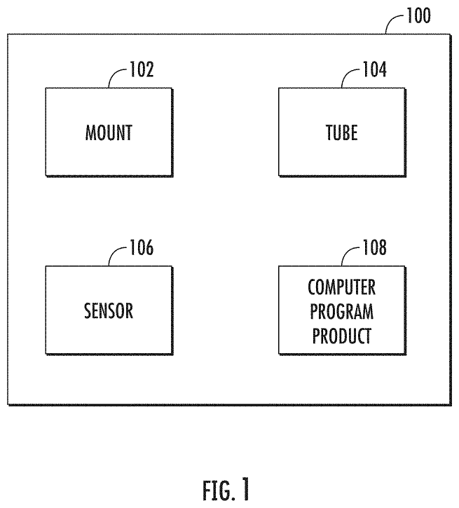

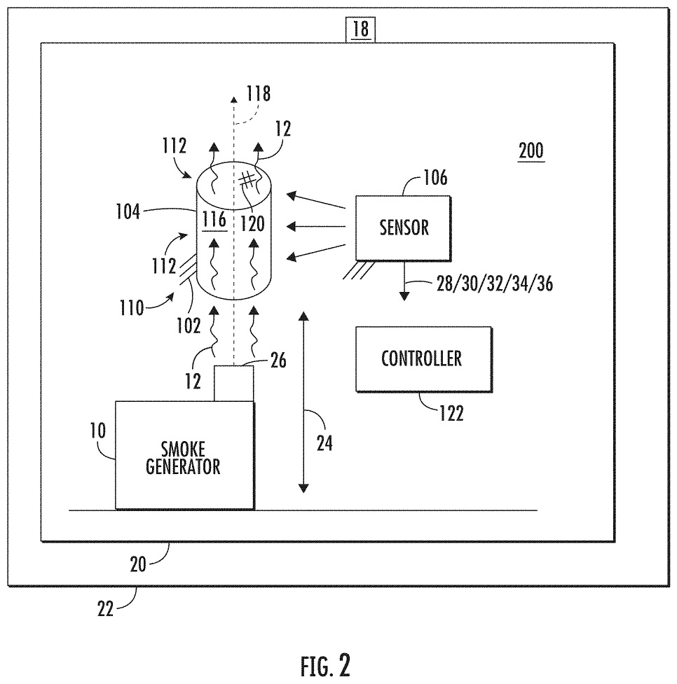

Reference will now be made to the drawings wherein like reference numerals identify similar structural features or aspects of the subject disclosure. For purposes of explanation and illustration, and not limitation, a partial view of an example of a test kit in accordance with the disclosure is shown in FIG. 1 and is designated generally by reference character 100. Other embodiments of test kits, test arrangements, test systems, and methods of monitoring performance of smoke generators are provided in FIGS. 2-4, as will be described. The systems and methods described herein can be used for monitoring performance of smoke generators, such as in smoke generators used for certification testing of fire suppression systems on aircraft, though the present disclosure is not limited to certification testing of fire suppression systems on aircraft or to testing of fire suppression systems on aircraft in general.

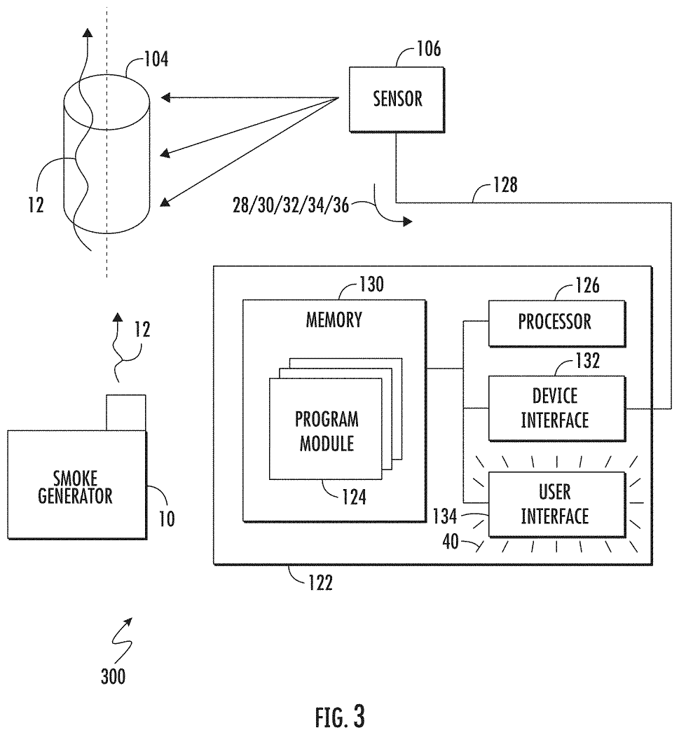

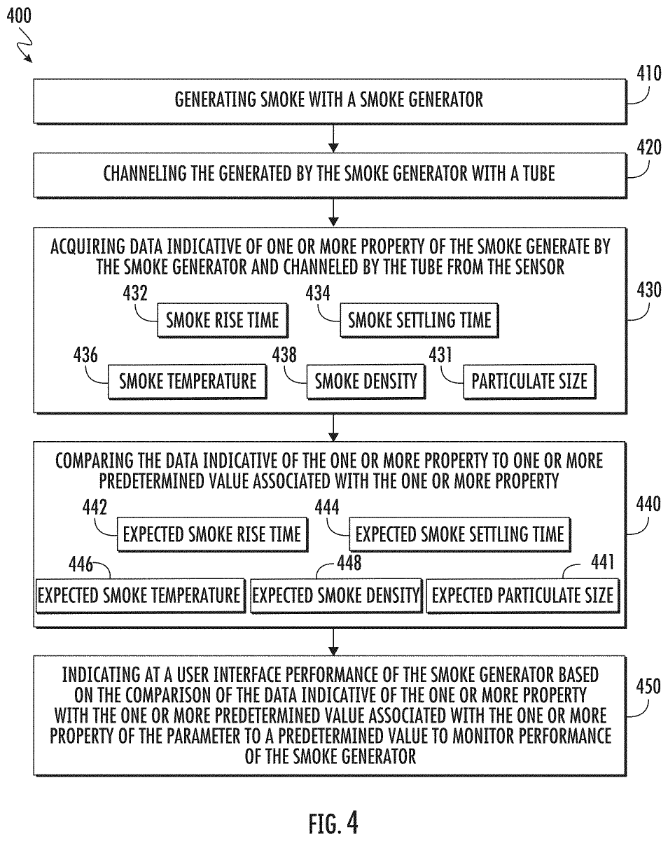

Referring to FIG. 1, the test kit 100 is shown. The test kit 100 includes a mount 102, a tube 104, a sensor 106, and a computer program product 108. The mount 102 is configured to support the tube 104 in a predetermined orientation and spacing in relation to a smoke generator, e.g., a smoke generator 10 (shown in FIG. 2), during performance monitoring of the smoke generator. The tube 104 is configured to channel smoke generated by the smoke generator 10, e.g., the smoke 12 (shown in FIG. 2), during performance monitoring of the smoke generator 10. The sensor 106 is configured to couple the tube 104 for acquiring data indicative of one or more property of the smoke 12 issued by the smoke generator 10 and channeled by the tube 104. The computer program product 108 includes a non-transitory machine-readable medium having a plurality of program modules recorded on it, e.g., a plurality of program modules 124 (shown in FIG. 3), having instructions that, when read by a processor, e.g., the processor 126 (shown in FIG. 3), cause the processor to undertake certain operations. Among those operations are operations of a method 400 (shown in FIG. 4) of monitoring performance of the smoke generator 10.

With reference to FIG. 2, a test arrangement 200 is shown. The test arrangement 200 includes the test kit 100 (shown in FIG. 1) and the smoke generator 10. The smoke generator 10 is fluidly coupled to a fire suppression system 18 by a protected space 20 and is arranged to generate the smoke 12 and issue (e.g., fluidly communicate) the smoke 12 to the protected space 20.

The fire suppression system 18 is disposed in communication with the protected space 20 and is configured to introduce a fire suppressant agent into the protected space 20 upon detection of fire within the protected space 20. In certain examples the protected space 20 is defined within a vehicle 22, e.g., an aircraft. In accordance with certain examples the protected space 20 is a cargo compartment defined within the vehicle 22. It is contemplated that, in accordance with certain examples, that the fire suppression system 18 be arranged to introduce a halon-type fire suppression agent into the protected space 20 when the fire suppression system detects presence of smoke, e.g., the smoke 12, within the protected space 20. Examples of suitable fire protection systems include Smoke Detection/Fire Extinguishing Class D fire suppression systems available from Kidde Technologies Inc. of Wilson, N.C.

As will be appreciated by those of skill in the view of the present disclosure, certain smoke generators can generate smoke having properties differing from smoke generated by other smoke generators. For example, smoke from some smoke generators may rise and/or settle more rapidly than smoke generated from other some generators. Smoke from certain smoke generators can also have different temperature, density, and/or particulate size than smoke generated by other smoke generated. As will also be appreciated by those of skill in the art in view of the present disclosure, properties of smoke generated by a specific some generator can mask the actual reliability of a fire suppression system during testing and/or certification of the fire suppression system, potentially causing an unreliable system to be commissioned or causing unnecessary repair and/or retesting of a reliable system. To avoid such situations the test kit 100, the test arrangement 200, the test system 300 (shown in FIG. 3), and the method 400 (shown in FIG. 4) of monitoring smoke generator performance are provided.

With continuing reference to FIG. 2, the mount 102 is arranged to support the tube 104. More specifically, the mount 102 is arranged to support the tube 104 in a predetermined orientation and at predetermined spacing distance 24 from the smoke generator 10. It is contemplated that the tube 104 be oriented vertically relative to gravity and be spaced apart from the smoke generator 10 by the predetermined spacing distance 24. In certain examples the mount 102 supports the tube 104 in registration relative to the smoke generator 10, i.e., above an outlet 26 of the smoke generator 10, to channel a relatively large portion of the smoke 12 issued by the smoke generator 10. In accordance with certain examples the tube 104 can be seated on the smoke generator 10, e.g., such that substantially all of the smoke 12 issued by the smoke generator 10 traverses the tube 104. However, as will be appreciated by those of skill in the art in view of the present disclosure, spacing the tube 104 from the smoke generator 10 reduces (or eliminates entirely) the influence that temperature of the smoke generator 10 has on temperature measurement of the portion of the smoke channeled by the tube 104.

The tube 104 has the first open end 110, the second open end 112, and an intermediate portion 114 coupling the first open end 110 to the second open end 112. The first open end 110, the second open end 112, and the intermediate portion 114 extends about an interior 116 of the tube 104. The interior 116 defines a channel axis 118 that is substantially vertical relative to gravity when the vehicle 22 is in straight and level flight. In certain examples the tube 104 is formed from a transparent material 120, e.g., an optically transparent material, such as glass or a polymeric material. In accordance with certain examples the tube 104 defines a diameter between the first open end 110 and the second open end 112, the tube 104 being substantially cylindrical in shape.

The sensor 106 is coupled to the tube 104. More specifically, the sensor 106 is coupled by the tube 104 to the interior 116 of the tube 104 for communication with the portion of the smoke 12 channeled by the tube 104. In certain examples the coupling of the sensor 106 to the interior 116 of the tube 104 is optical. In accordance with certain examples the coupling of the sensor 106 to the interior of the tube 104 is thermal. It is also contemplated that the coupling of the sensor 106 can be electromagnetic, e.g., via electromagnetic radiation outside the visible wavebands of the electromagnetic spectrum like infrared and/ow shortwave infrared wavebands.

The sensor 106 can be coupled to a portion of the tube 104 or to the entirely of the tube 104. In this respect the sensor 106 can be coupled to the first open end 110 of the tube 104. Alternatively (or additionally), the sensor 106 can be coupled to the second open end 112 of the tube 104. Further, it also contemplated that the sensor 106 can alternatively (or additionally) be coupled to the intermediate portion 114 of the tube 104.

It is contemplated that the sensor 106 be configured to acquire data relating to one or more property of the portion of the smoke 12 channeled by the tube 104. In certain examples the sensor 106 is configured to generate rise time data 28 of the smoke 12 as the some rises between the first open end 110 and the second open end 112 of the tube 104. In accordance with certain examples is configured to generate smoke settling time data 30 of the smoke 12 as the smoke 12 settles between the second open end 112 and the first open end 110 of the tube 104. It is contemplated that, in accordance with certain examples, that the sensor 106 be configured to generate smoke temperature data 32 and/or smoke density data 34 of the smoke 12 within the interior 116 of the tube 104, e.g., at one or more of the first open end 110, the second open end 112, and/or the intermediate portion 114 of the tube 104. It is also contemplated that the sensor 106 be configured to acquire particle size data 36 of the smoke 12 within the interior of the tube 104, e.g., at one or more of the first open end 110, the second open end 112, and/or the intermediate portion 114 of the tube 104.

In certain examples the sensor 106 is coupled to two or more portions of the tube 104, i.e., to two or more of the first open end 110, the second open end 112, and/or the intermediate portion 114. As will be appreciated by those of skill in the art, coupling the sensor 106 to the first open end 110 and the second open end 112 of the tube 104 enables the sensor to acquire data relating to smoke rise time and/or smoke settling time by utilizing the entirely of the length of the tube 104. As will be also be appreciated by those of skill in view of the present disclosure, coupling the sensor 106 to each of first open end 110, the second open end 112, and the intermediate portion 114 of the tube 104 enables the sensor to acquire data relating to smoke density and smoke temperature throughout the entirety of the interior 116 of the tube 104. As also shown in FIG. 2, the sensor 106 is disposed in communication with a controller 122 through a link 128, e.g., with a wired or wireless link, to communicate the one or more of the rise time data 28, the smoke settling time data 30, the smoke temperature data 32, the smoke density data 34, and/or the particle size data 36 to the controller 122, which contains the computer program product 108 (shown FIG. 1).

With reference to FIG. 3, a test system 300 is shown. The test system 300 includes the test arrangement 200 and the controller 122. The controller 122 includes the processor 126, a non-transitory machine-readable memory 130, a device interface 132, and a user interface 134. The device interface 132 is connected to the link 128, and therethrough to the sensor 106 for acquiring thereby for acquiring one or more of the rise time data 28, the smoke settling time data 30, the smoke temperature data 32, the smoke density data 34, and/or the particle size data 36.

The processor 126 is operably connected to the user interface 134 and is disposed in communication with the device interface 132 and the memory 130. The memory 130 includes the computer program product 108 (shown in FIG. 1) and has recorded on it the plurality of program modules 124. The plurality of program modules 124 have instruction that, when read by the processor 126, cause the processor to undertake certain operations. Among those operations are operations of the method 400 (shown in FIG. 4) of monitoring performance of a smoke generator, e.g., the smoke generator 10.

With reference to FIG. 4, the method 400 of monitoring performance of a smoke generator, e.g., the smoke generator 10 (shown in FIG. 2), is shown. As shown with box 410, the method 400 includes generating smoke, e.g., the smoke 12 (shown in FIG. 2). The smoke generated by the smoke generator is channeled by a tube, e.g., the tube 104 (shown in FIG. 1), which is supported in a predetermined orientation and at a predetermined spacing distance from the smoke generator, as shown with box 420.

As shown with box 430, data is acquired that is indicative of one or more property of the smoke generated by the smoke generator and channeled by the tube using a sensor, e.g., the sensor 106 (shown in FIG. 1). In certain examples the data is indicative of smoke rise time between the first open end and the second open end of the tube, e.g., between the first open end 110 (shown in FIG. 2) and the second open end (shown in FIG. 2), as shown with box 432. In accordance with certain examples the data is indicative of smoke settling time between the second open end and the first open end of the tube, as shown with box 434. In accordance with certain examples the data is indicative of one or more of smoke temperature, some density, and/or particulate size, as shown with box 436, box 438, and box 431. It is contemplated that data can be acquired from an intermediate portion of the tube, e.g., the intermediate portion 114 (shown in FIG. 2), as an alternative or in addition to one of more of the first open end and the second open end of the tube.

As shown with box 440, the data indicative of the one or more property of the smoke is compared to a predetermined value associated with the one or more property. For example, acquired data indicative of smoke rise time can be compared to a predetermined expected smoke rise time value, as shown with box 442. Acquired data indicative of smoke settling time can be compared to a predetermined expected rise time value, as shown with box 444. In accordance with certain examples acquired data indicative of smoke temperature can be compared to a predetermined expected smoke temperature, acquired data indicative of smoke density can be compared to a predetermined expected smoke density value, and/or acquired data indicative of particle size can be compared to a predetermined expected particle size, as shown with box 446, box 448, and box 441. It is contemplated that the predetermined expected value be recorded on a memory, e.g., within one of the plurality of program modules 124 (shown in FIG. 3) recorded on the memory 130 (shown in FIG. 3). It is also contemplated that the predetermined expected value can be representative of a benchmark smoke generator or a summary statistic of a group of characterized smoke generators.

As shown with box 450, an indication, e.g., an indication 40 (shown in FIG. 3), is provided to a user interface, e.g., the user interface 134 (shown in FIG. 3). The indication is based on the comparison of the acquired data indicative of the one or more property of the smoke channeled by the tube and the associated predetermined expected value of the one or more property. In certain examples the value is binary “GO/NO GO” indicia. In accordance with certain examples the indicator is a normalization factor for a fire suppression system in communication with the protected space within which the smoke is issued, e.g., the fire suppression system 18 (shown in FIG. 2). In such examples the normalization factor is applied to a performance parameter or property of the fire suppression system and the normalized performance property used to assess reliability of the fire suppression system.

Fire suppression systems are commonly tested to assess the reliability of the fire suppression system, such as during certification and/or subsequent to maintenance. The testing generally includes introducing smoke into a protected space to which the fire suppression system is communicative, typically using a smoke generator. Since the performance of the smoke generator used in a particular test can vary in relation to other smoke generators and/or the smoke generator population generally, certain smoke generators can make the fire suppression system undergoing test appear more or less reliable than is actually the case.

In examples described herein test kits are employed for monitoring the performance of smoke generators employed in testing fire suppression systems. The kits employ tube and a sensor coupled to tube and in communication with a controller, and to acquire data indicative of one or more property of smoke generated by the smoke generator. The data is compared to a predetermined reference value and an indication of the smoke generator performance provided to a user interface. The indication can be used to assess the reliability of the results of the fire suppression test and/or normalize the results of the test, limiting (or eliminating entirely) probability that an unreliable system passes the test and that a reliable system passes the test.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A test kit for testing fire suppression systems, comprising:
a tube arranged to channel smoke generated by a smoke generator;
a mount arranged to support the tube relative to the smoke generator in a predetermined orientation and a predetermined spacing relative to the smoke generator; and
a sensor arranged for coupling to the tube, wherein the sensor is configured to generate data indicative of one or more property of the smoked generated by the smoke generator and channeled by the tube to monitor some generator performance.

2. The test kit of claim 1, further comprising a computer program product including a plurality of program modules having instructions that, when read by a processor, cause the processor to:
acquire data indicative of the one or more property of the smoke generated by the smoke generator and channeled by the tube;
compare the data indicative of the one or more property to one or more predetermined value associated with the one or more property; and
indicate, at a user interface operatively associated with the processor, performance of the smoke generator based on the comparison of the data indicative of the one or more property with the one or more predetermined value associated with the one or more property.

3. A test arrangement testing fire suppression systems, comprising:
a smoke generator; and
a test kit as recited in claim 1, wherein the tube is supported by the mount in the predetermined orientation and at the predetermined spacing relative to the smoke generator.

4. The test arrangement of claim 3, wherein the tube has a first open and a second open end coupled to the first open end by an intermediate portion of tube, wherein the tube is supported by the mount such that the second open end is above the first open end relative to gravity.

5. The test arrangement of claim 4, wherein the sensor is coupled first open end and the second open end of the tube to generate at least one of smoke rise time and smoke settling time data of smoke channeled by the tube.

6. The test arrangement of claim 4, wherein the sensor is coupled to one or more of the first open end, the second open end, and the intermediate portion of the tube to generate data indicative of one or more of smoke temperature, smoke density, and/or particulate size within an interior of the tube.

7. The test arrangement of claim 3, wherein the tube is formed from a transparent material, and wherein the tube optically couples the sensor to smoke channeled by the tube and/or disposed within an interior of the tube.

8. The test arrangement of claim 3, wherein the mount supports the sensor relative to the tube.

9. The test arrangement of claim 3, further comprising:
a link connected to the sensor; and
a controller connected to the link and therethrough to the sensor, the controller configured to:
acquire data indictive of the one or more property of the smoke generated by the smoke generator and channeled by the tube;
compare the data indicative of the one or more property to one or more predetermined value associated with the one or more property; and
indicate, at a user interface operatively associated with the controller, performance of the smoke generator based on the comparison of the data indicative of the one or more property with the one or more predetermined value associated with the one or more property.

10. The test arrangement of claim 3, wherein the sensor is configured to generate data indicative of one or more of (a) smoke rise time, (b) smoke settling time, (c) smoke temperature, (d) smoke density, and (e) particulate size.

11. A test system for testing fire suppression systems, comprising:
a smoke generator;
a test kit as recited in claim 1, wherein the tube is supported by the mount in the predetermined orientation and at the predetermined spacing relative to the smoke generator, wherein the sensor is coupled to the tube; and
a controller disposed in communication with the sensor with a processor and a memory, the memory having a plurality of program modules recorded on the memory that, when read by the processor, cause the processor to:
acquire data indictive of the one or more property of the smoke generated by the smoke generator and channeled by the tube;
compare the data indicative of the one or more property to one or more predetermined value associated with the one or more property; and
indicate, at a user interface operatively associated with the controller, performance of the smoke generator based on the comparison of the data indicative of the one or more property with the one or more predetermined value associated with the one or more property.

12. The test system of claim 11, wherein the sensor is coupled first open end and the second open end of the tube, and wherein the data is one of smoke rise time and smoke settling time within an interior of the tube.

13. The test system of claim 11, wherein the sensor is coupled to wherein the sensor is coupled to one or more of the first open end, the second open end, and the intermediate portion of the tube; and wherein the data is indicative of one or more of smoke temperature, smoke density, and particulate size.

14. A method of monitoring performance of a smoke generator, comprising:
at a test arrangement including a smoke generator and a test kit including a tube, a mount, and a sensor, wherein the tube is supported by the mount in the predetermined orientation and at the predetermined spacing relative to the smoke generator;
generating smoke with the smoke generator;
channeling the smoke generated by the smoke generator with the tube;
acquiring data indicative of one or more property of the smoke generated by the smoke generator and channeled by the tube from the sensor;
comparing the data indicative of the one or more property to one or more predetermined value associated with the one or more property; and
indicating at a user interface performance of the smoke generator based on the comparison of the data indicative of the one or more property with the one or more predetermined value associated with the one or more property to monitor performance of the smoke generator.

15. The method of claim 14, wherein the data includes smoke rise time, and wherein the predetermined value includes an expected smoke rise time between a first open end and a second open end of the tube.

16. The method of claim 14, wherein the data includes smoke settling time, and wherein the predetermined value includes an expected smoke settling time between a second open end and a first open end of the tube.

17. The method of claim 14, wherein the data includes smoke temperature, and wherein the predetermined value includes an expected smoke temperature.

18. The method of claim 14, wherein the data includes smoke density, and wherein the predetermined value includes an expected smoke density of the smoke channeled by the tube.

19. The method of claim 14, wherein the data includes particulate size, and wherein the predetermined value includes an expected particulate size of the smoke channeled by the tube.

20. The method of claim 14, further comprising normalizing a response of a fire suppression system in communication with smoke to the data indicative of one or more property of the smoke.
